(19) United States
(12) Patent Application Publication
(10) Pub. No.: US 2013/0271092 A1
(43) Pub. Date: Oct. 17, 2013

(54) Ultra-Capacitor Based Energy Storage for Appliances

(71) Applicant: Shekhar Y. Borkar, Beaverton, OR (US)

(72) Inventor: Shekhar Y. Borkar, Beaverton, OR (US)

(21) Appl. No.: 13/992,717

(22) PCT Filed: Dec. 30, 2011
(86) PCT No.: PCT/US11/68046

§ 371 Date: Jun. 8, 2013

(51) Int. Cl. H02J 7/00

(52) U.S. Cl. CPC H02J 7/00
USPC 320/167

(57) ABSTRACT

An ultra-capacitor may replace a rechargeable battery in consumer applications where the appliance usage is not prolonged. That is, if the usage is intermittent, the ultra-capacitor can quickly recharge between consecutive uses. Especially for those applications where an appliance spends most of the time on a charging cradle ultra-capacitor may efficiently replace batteries in appliances.

### BACKGROUND

This relates to ultra-capacitor powered appliances.

An ultra-capacitor based appliance typically uses a single capacitor or a series/parallel combination of several capacitors. When capacitors are connected in parallel, the effective capacitance increases, providing higher energy storage. Today, ultra-capacitors are limited to 2.7 Volts. Therefore, to increase their output voltage, capacitors are connected in series, which reduces their capacitance. However, since the stored energy is proportional to the square of the voltage, higher energy storage at higher voltages may result.

An ultra-capacitor is also known as a super capacitor, a super condenser, or an electric double-layer capacitor. They are distinguished from other capacitors because they have a separator between two plates, that effectively creates a double capacitor.

### BRIEF DESCRIPTION OF THE DRAWINGS

Some embodiments are described with respect to the following figures:

FIG. 1 is a perspective view of a toothbrush according to one embodiment;

FIG. 2 is a perspective view of a screwdriver according to one embodiment;

FIG. 3 is a perspective view of a drill according to one embodiment;

FIG. 4 is a perspective view of a flashlight according to one embodiment;

FIG. 5 is a schematic depiction for one embodiment;

FIG. 6 is a hypothetical graph of voltage versus relative energy used for one embodiment;

FIG. 7 is a more detailed schematic depiction of the regulator of FIG. 5, according to one embodiment;

FIG. 8 is a depiction of the charging circuit shown in FIG. 5 according to one embodiment;

FIG. 9 is circuit schematic for a voltage reference generator according to one embodiment;

FIG. 10 is a circuit schematic for developing a sensing voltage for the sensing block according to one embodiment;

FIG. 11 is a circuit schematic for an up-down control in the limit detect shown in FIG. 7 according to one embodiment;

FIG. 12 is a low voltage alert circuit for one embodiment;

FIG. 13 is a circuit to turn off the voltage converter used in the circuit 44 according to one embodiment;

FIG. 14 is one embodiment of an up/down converter; and

FIG. 15 shows the waveforms for operation of the voltage converter according to one embodiment.

### DETAILED DESCRIPTION

An ultra-capacitor may replace a battery, such as are a rechargeable battery, in consumer applications where the appliance usage is not prolonged. That is, if the usage is intermittent, the ultra-capacitor can quickly recharge between consecutive uses. Especially for those applications where an appliance spends most of the time on a charging cradle, ultra-capacitor may efficiently replace batteries in appliances.

An ultra-capacitor uses a charging circuit to replace the conventional rechargeable batteries, such as NiCd, NiMH, or Li-ion. Single or multiple ultra-capacitors can be employed in series/parallel combination to store electric charge with a simple resistor to limit current. An electronic charging circuit charges the capacitor, and an electronic voltage converter maintains constant voltage to the appliance. The number of capacitors in series and parallel depends on the voltage, energy storage, and typical usage time.

When the appliance is turned on, it uses energy from the capacitor (instead of a battery). The capacitor discharges as energy is consumed by the appliance, reducing the capacitor's output voltage. Although the electronics converts the output voltage to acceptable value for the appliance, the size of the capacitor may be chosen appropriately such that the capacitor is large enough to hold the amount of energy necessary for the duration of the typical intermittent use of the appliance.

The capacitor in the appliance can be charged quickly between the intermittent uses by replacing it on the charging cradle. If the charging cradle is capable of charging the capacitor at high currents, the charging time between intermittent uses can be relatively small.

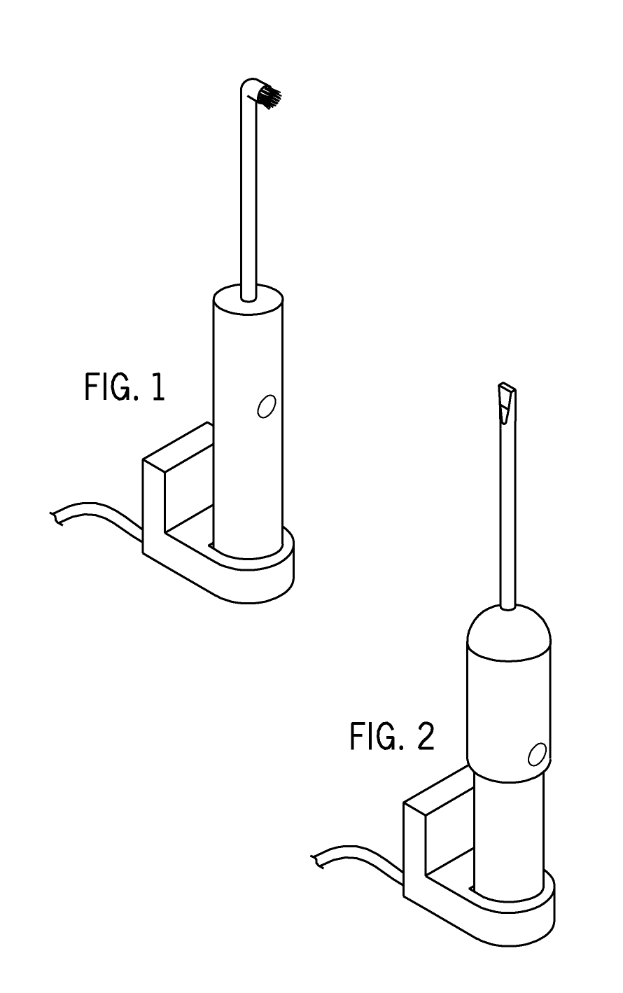

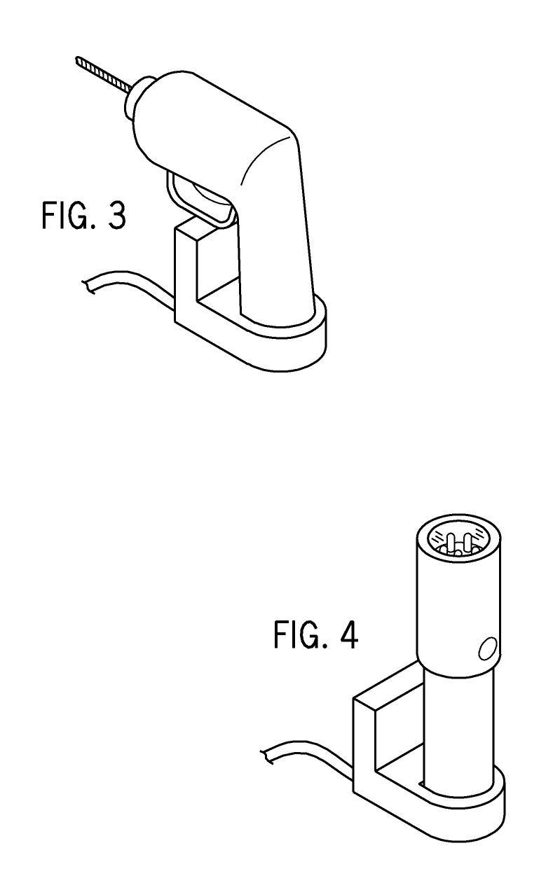

Potential applications include the electric toothbrush shown in FIG. 1, electric screwdriver shown in FIG. 2, an electric drill shown in FIG. 3 and a flashlight shown in FIG. 4. Any appliance used for a short period of time between charging cycles, may be suited for use with an ultra-capacitor power source.

Ultra-capacitors have very long life, typically 30 years or so, compared to a rechargeable battery whose life is two to three years. Standard disposable batteries have even shorter lifetimes. Ultra-capacitors do not use toxic chemicals like batteries do, making them “greener”. Ultra-capacitor based batteries may be lighter weight. Ultra-capacitor based solutions may be inexpensive in the future as the technology matures compared to rechargeable batteries.

Ultra-capacitors exhibit leakage, (represented by Rleak), causing discharge. Also, when the capacitors are used in a series combination to increase voltage, leakage resistors are purposely added to even out the discharge of all the capacitors in the series stack. If the leakage is not evened out, uneven discharge could raise the voltage across a capacitor beyond its maximum rated voltage, harming the capacitor.

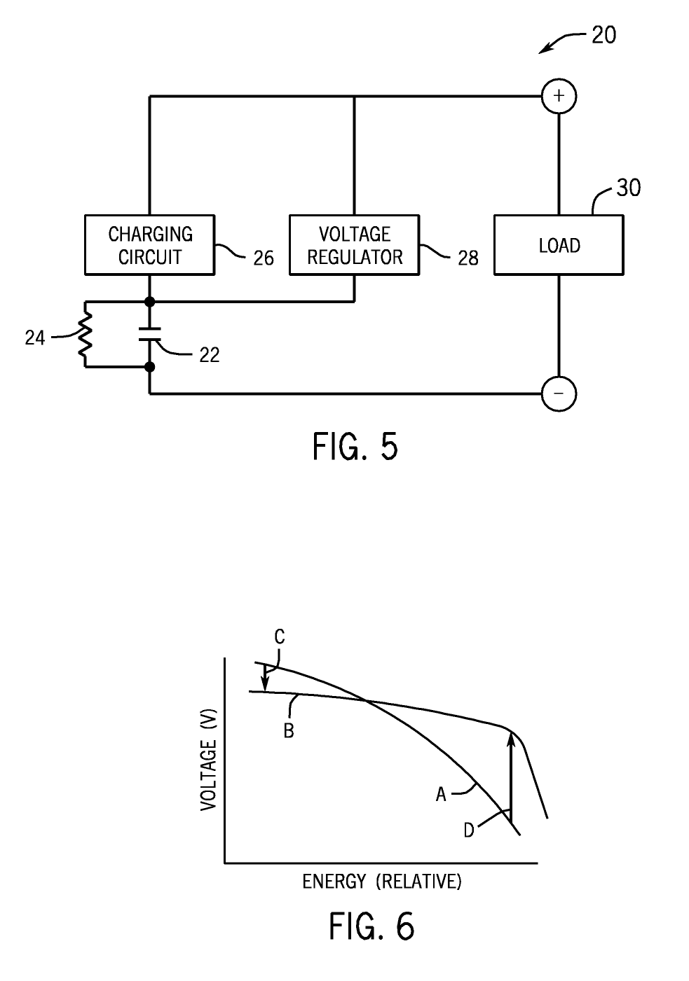

As shown in FIG. 5, an ultra-capacitor based appliance 20 may include a capacitor 22 charged from the charging circuit 26. A leakage resistor 24 may be used in some embodiment. When charged, either fully to the charging voltage or to a high enough voltage, the capacitor provides a supply voltage to the load 30. As the load consumes energy from the capacitor, the voltage across the capacitor reduces, and hence the appliance (the load) experiences gradual reduction in supply voltage with use, potentially compromising effectiveness.

Hence one possible solution is to use a large capacitor so that the voltage reduction is not as much. However, a larger ultra-capacitor may be bulkier, more expensive, and take a longer time to charge a large capacitor.

In some embodiments, where the capacitor is smaller, the drop in capacitor voltage may be compensated by a voltage regulator 28 that presents a substantially constant voltage to the load. As used herein, a “substantially constant” voltage is a voltage that does not vary by more than twenty percent (20%) between charges.

Ultra-capacitors and associated electronics provide the necessary electric energy to the appliance which is used intermittently. The electronic circuit 20 provides the final voltage to the appliance and the ultra-capacitor is charged using any conventional charging method.

FIG. 6 shows a hypothetical discharge characteristics B of a battery which provides substantially constant voltage to the load. As energy is consumed out of the battery (X axis) the voltage at the terminal of the battery is fairly constant, at around 1.2V for a rechargeable battery. When it reaches a certain energy threshold, then the voltage drops rapidly. FIG. 6 shows characteristics of a hypothetical capacitor A, where voltage continues to drop as the energy is consumed.

Therefore, employing a capacitor as-is for energy storage would not be ideal for the appliance. Instead voltage regulator 28 maintains a substantially constant voltage, such as 1.2 volts for a rechargeable application. Electronics can be used to provide a substantially constant voltage from the discharging capacitor to the load. As the energy storage in the capacitor reaches a certain threshold, the electronics asserts an alert signal indicating that energy reserves are getting low, so the appliance can alert the user to recharge. For example, in the cordless phone a red light starts blinking when the energy level is low.

Initially, the output voltage of the capacitor may be reduced to track the typical discharge characteristics B being replaced. Then after some point in time, it may be necessary to actually boost the voltage to emulate the discharge characteristics of the battery being replaced. Thus during the initial phase of discharge, the capacitor's discharge characteristic may be reduced to produce a lower voltage, as indicated by the arrow C, and then at some point in time it may be necessary to increase the output voltage, as indicated by the arrow D.

The ultra-capacitor is charged from the external source (charging voltage) using charging circuit 26 shown in FIG. 5. During the charging operation, the rest of the electronics may be disabled since the energy is supplied to the capacitor.

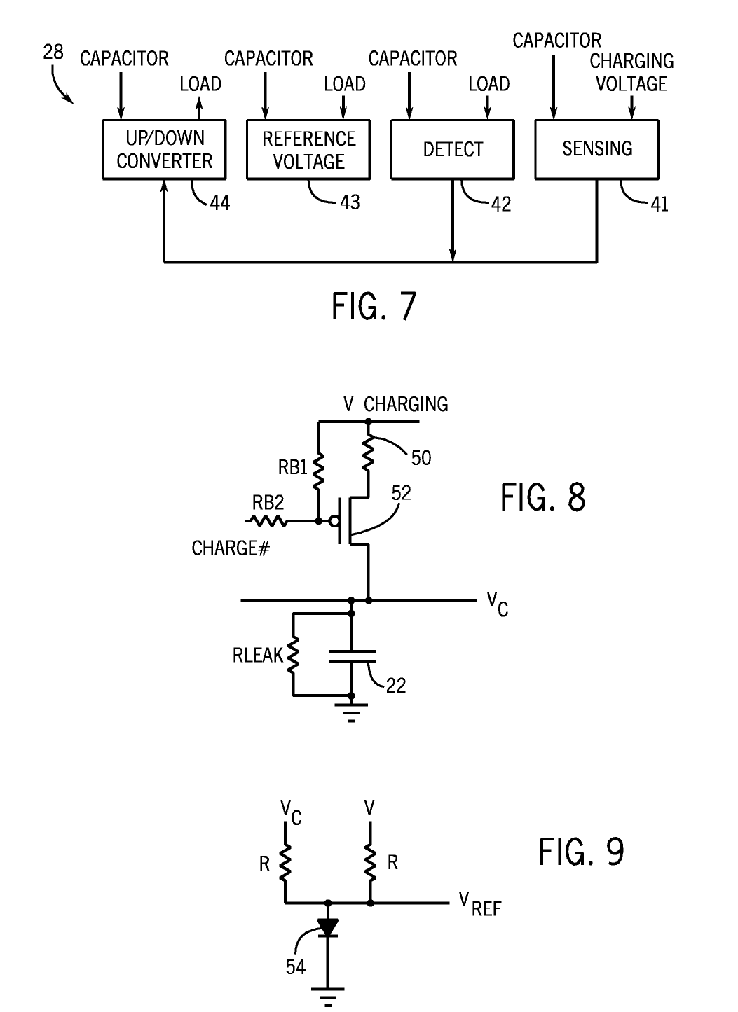

Referring to FIG. 7, the regulator 28 may include voltage sensing block 41. When the sensing block 41 senses that the applied voltage is higher than the voltage across the capacitor, it turns the converter 44 off, and enables the charging circuit 26 (FIG. 5) to charge the capacitor 22 (FIG. 5).

When the charging voltage is removed, the detect block 42 detects that charging has ceased, turns off the charging circuit and starts the up/down converter 44 to convert voltage across the capacitor to the voltage required for the load. Sensing block 41 senses capacitor voltage to see if it is higher than a nominal voltage necessary for the load or not, and sets the direction of the up/down converter 44 so that the converter can convert voltage across the capacitor in the correct direction.

When the capacitor is fully charged at the charging voltage, this voltage may be converted down to present to the load. When the energy from the capacitor gets consumed, the voltage drops, and as it falls below the load voltage, the detect block 42 changes the direction of the converter to up convert, so the capacitor voltage is converted to a higher value.

As a result, the load experiences a substantially constant voltage even though the voltage across the capacitor varies from higher than load, at full charge, to lower than load, with energy consumption. As the energy in the capacitor drops, the detect block 42 detects the threshold where it needs create a low energy alert signal. Finally, when the voltage across the capacitor becomes too low for proper operation of the converter, the limit detect circuit 42 detects the limit and turns off the converter.

The reference voltage generator 43 creates a constant reference voltage. This constant reference voltage is used by the entire system to compare voltages against this reference voltage. The charging circuit charges the ultra-capacitor with a current limiter. The load control signal charge# starts charging the capacitor. When the capacitor voltage asymptotically approaches the charging voltage V, the charging current is reduced. So the capacitor is charged, at the most, to voltage V.

The charging circuit 26 shown in FIG. 8 employs a PMOS transistor 52 with the resistor 50 used to limit the charging current. When the control signal charge# on the gate of the transistor 52 is asserted low by the sensing block 41, indicating that charging voltage is applied, the PMOS transistor is turned on to charge the capacitor 22. The voltage across the capacitor increases almost linearly, first with fast charging, and then asymptotically settles down to the applied charging voltage.

FIG. 9 shows a voltage reference generator 43 using a forward biased diode 54. The voltage across the diode is derived from the load as well as from the capacitor. The voltage across the diode is fairly constant, around 0.6V in one embodiment.

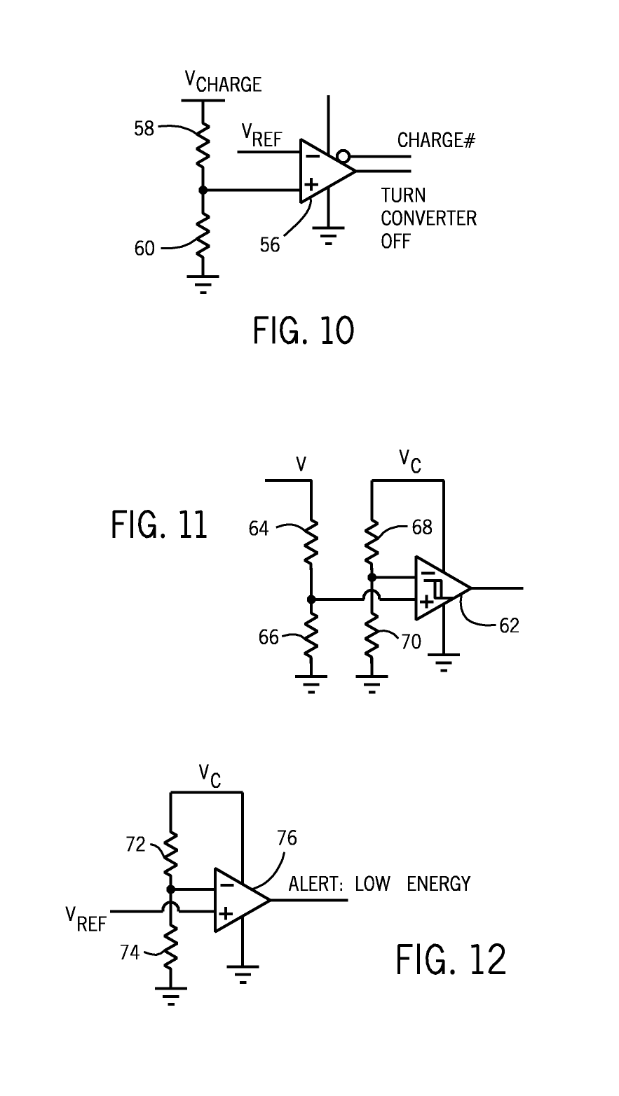

The sensing voltage for the converter in sensing block 41 may be developed by the circuit shown in FIG. 10. In this circuit, the operational amplifier 56 compares a ratio (created by resistors 58 and 60) of the charging voltage (V_{CHARGE}) with the reference voltage (V_{REF}). If the charging voltage is high enough, then that indicates the capacitor is being charged. The operational amplifier asserts a charge# signal to enable the charging circuit and turns off the up/down converter. If the charging voltage is low, then the charging circuit is turned off and the up/down converter is enabled to provide voltage to the load.

FIG. 11 shows an up/down control implemented in the limit detect circuit 42. This circuit determines the up or down mode of conversion by comparing the capacitor voltage Vc with the load voltage V.

The comparator 62 may be an operational amplifier implemented with hysteresis for stable decision at the output without any oscillations. The inputs compare a fixed ratio of the load voltage created by resistors 64 and 66, against the ratio of voltage across the capacitor created by resistors 68 and 70. If the voltage across the capacitor is higher than the terminal voltage then it asserts down convert at the output, and vice versa. The output signal tells the converter whether to convert the capacitor's voltage up or down to produce a substantially constant voltage for the load.

As the capacitor energy gets consumed, the voltage across the capacitor falls, and it reaches a point where limited energy is left in the appliance may provide an indication to the user that limited energy is left, for example by illuminating a red light. FIG. 12 shows a circuit to create such an alert signal. In FIG. 12, the operational amplifier 76 compares a voltage ratio formed by resistors 72 and 74 of the capacitor voltage against the reference voltage to determine whether it should create the alert signal.

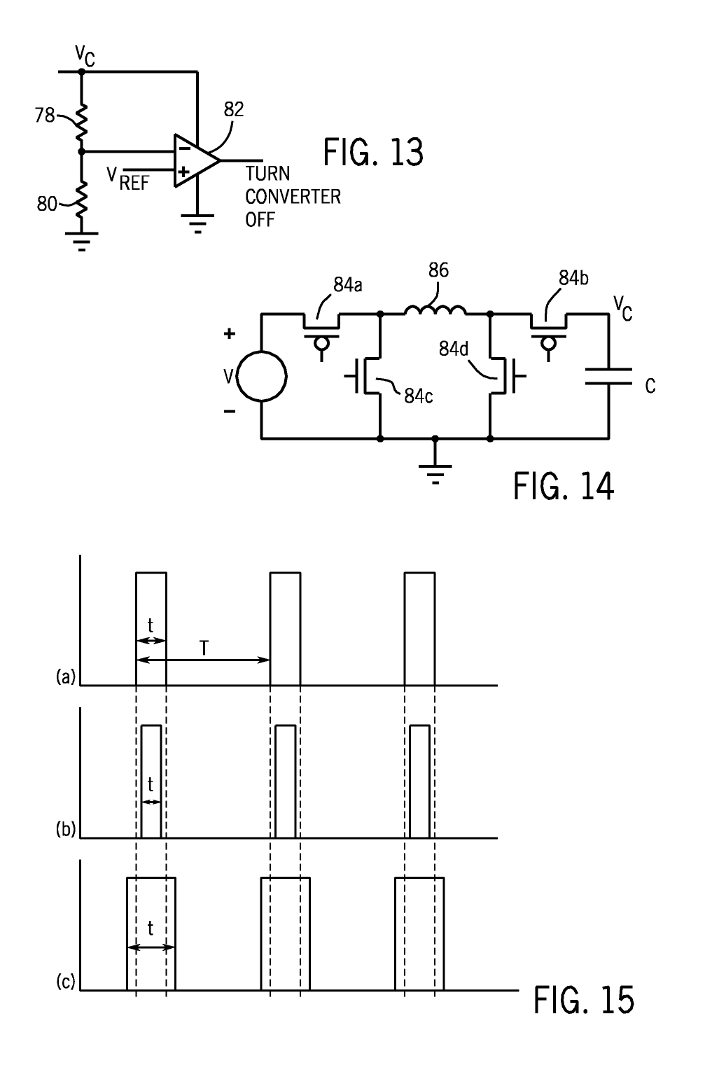

The capacitor voltage continues to fall due to energy consumption. When it reaches the limit where the voltage converter may not operate reliably, the circuit shown in FIG. 13 turns off the voltage converter. The two resistors, 78 and 80, create a ratio of the capacitor voltage which is compared against the reference, and if the voltage is too low then the operational amplifier 82 signals the converter to turn off.

There are several ways to implement a voltage converter to convert voltage across the capacitor to the terminal voltage. Switching regulators or converters, also called Buck converters, switched capacitor converters, and linear voltage regulators (down only) can be used while switching converters are disclosed as other schemes may also be used.

FIG. 14 shows the operation of the converter 44 (FIG. 7) using MOS transistors 84 as switches. The converter steps the voltage down using transistors 84a and 84c when the voltage across the capacitor is higher than the terminal voltage. The switches 84b and 84d step up convert when the voltage across the capacitor falls below the terminal voltage.

FIG. 15 shows typical switching diagram depicting the operation of a converter with pulse width modulation. The vertical axis is voltage and the horizontal axis is time. The nominal pulse width t and the nominal period T are shown in FIG. 15a. Then in FIG. 15b, the nominal pulse width t is reduced. This is because of the situation where the sense voltage is greater than the reference voltage so that there is a higher terminal voltage. This results in reducing the current in the inductor 86 of the up/down converter shown in FIG. 14. To accommodate this situation, the pulse width is reduced. In FIG. 15c the pulse width t is increased because the sense voltage is less than the reference voltage. This means there is a lower terminal voltage and so it is necessary to increase the current in the inductor 86 (FIG. 14).

All of the active circuits described above can be implemented with either discrete or integrated electronics. An integrated version will undoubtedly be smaller and efficient. Passive elements such as capacitors and inductors are fairly small, and they could be discrete, or they could be integrated with the electronics as well. The size of the electronics is very small compared to the volume of typical batteries in the appliance, and most of the volume can be dedicated to the ultra-capacitor for energy storage.

MOS transistors are shown but bipolar transistors can be substituted without losing generality. For appliances with loads of low voltages, MOS transistors are probably more suitable since they have low threshold voltage Vt than forward bias voltage Vbe of a bipolar transistor, making circuits easy to design and more efficient. For higher voltages either MOS or bipolar transistors are equally suitable.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a tool; and
a power source for said tool including a ultra-capacitor and a voltage regulator to modify the voltage output from the ultra-capacitor to reduce the voltage at higher charge levels and to increase the output voltage at lower charge levels.

2. The apparatus of claim 1 wherein said tool is one of a toothbrush, a screwdriver, a drill, or a flashlight.

3. The apparatus of claim 1 wherein said voltage regulator attempts to hold the output voltage at between about 1 and 2 volts.

4. The apparatus of claim 1 wherein tool is an intermittent use tool.

5. The apparatus of claim 1 wherein said power source outputs a substantially constant voltage.

6. The apparatus of claim 5 wherein said voltage is about 1.2 volts.

7. The apparatus of claim 1 wherein said voltage regulator includes a step down and a step up voltage converter to maintain a substantially constant output voltage.

8. The apparatus of claim 1, said voltage regulator to trigger a low voltage indicator.

9. A method comprising:
modifying the voltage output from an ultra-capacitor to reduce the voltage at higher charge levels and to increase the output voltage at lower charge levels.

10. The method of claim 9, including using said ultra-capacitor to power a toothbrush, a screwdriver, a drill, or a flashlight.

11. The method of claim 9, including attempting to hold the output voltage at between about 1 and 2 volts.

12. The method of claim 9, including using said ultra-capacitor to power an intermittent use tool.

13. The method of claim 9, providing a substantially constant voltage from said capacitor.

14. The method of claim 13 wherein providing includes providing a voltage of about 1.2 volts.

15. The method of claim 9, including using a step down and a step up voltage converter to maintain a substantially constant output voltage.

16. The method of claim 9, including triggering a low voltage indicator.

17. A circuit comprising:
an ultra-capacitor; and
a voltage regulator to modify the voltage output from the ultra-capacitor to produce a substantially constant output voltage.

18. The circuit of claim 17 wherein said voltage regulator attempts to hold the output voltage at between about 1 and 2 volts.

19. The circuit of claim 17 wherein said voltage is about 1.2 volts.

20. The circuit of claim 17 wherein said voltage regulator includes a step down and a step up voltage converter to maintain a substantially constant output voltage.

21. The circuit of claim 17, said voltage regulator to trigger a low voltage indicator.
